(19) United States
(12) Patent Application Publication
(10) Pub. No.: US 2010/0226320 A1
(43) Pub. Date: Sep. 9, 2010

(54) WIRELESS TRANSMISSION APPARATUS, WIRELESS RECEPTION APPARATUS, AND TRANSMISSION METHOD

(75) Inventor: Yutaka ASANUMA, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/546,757

(22) Filed: Aug. 25, 2009

(30) Foreign Application Priority Data
Mar. 3, 2009 (JP) 2009-049368

(51) Int. Cl. H04W 72/04

(52) U.S. Cl. 370/329

(57) ABSTRACT

A wireless se station notifies a mobile wireless terminal of type y of LTE-A of the assignment information of a representative channel (PDSCH) via a PDCCH, as in a mobile wireless terminal of type x of Rel-8 LTE, and notifies the terminal of the remaining assigned channels (PDSCHs) via a region (D) of the notified representative channel.

### CROSS-REFERENCE TO RELATED APPLICATIONS

This application is based upon and claims the benefit of priority from prior Japanese Patent Application No. 2009-049368, filed Mar. 3, 2009, the entire contents of which are incorporated herein by reference.

### BACKGROUND OF THE INVENTION

1. Field of the Invention

The present invention relates to communication between a wireless base station apparatus and a mobile wireless terminal apparatus which are accommodated in a network.

2. Description of the Related Art

A mobile communication system such as a cellular system uses various parameters for defining the transmission/reception capability of a terminal to support terminals of various application purposes (e.g., 3GPP (3rd Generation Partnership Project) TS 36.306 V8.2.0 (2008 05)). Combinations of parameters define NE categories. Terminal capabilities (NE capabilities) that define the NE categories include a maximum information transmission rate which is defined on each of the transmitting and receiving sides. A base station transmits/receives signals to/from a plurality of terminals based on their different transmission and reception capabilities. The 3GPP (3rd Generation Partnership Project) TS 36.306 V8.2.0 (2008 05) suggests that a base station should be able to simultaneously connect terminals of different categories.

Recently, an LTE-Advanced (LTE-A) system has been examined, which uses a broadband including a system band that is the receivable bandwidth of a Rel-8 LTE terminal. To operate the Rel-8 LTE terminal using narrowband in the new system using a broadband, the base station of the new system needs to transmit a signal that is receivable by the Rel-8 LTE terminal as well.

The Rel-8 LTE terminal starts its operation ahead of the new system. It is therefore difficult to change the reception band of the Rel-8 LTE terminal later at the start of the operation of the new system. In addition, the ratio of Rel-8 LTE terminals that exist in the radio zone of one base station to terminals (“LTE-A terminals” hereinafter) that use the broadband there dynamically changes. For this reason, the LTE system that assigns information transmission channels via control channels requires some contrivance on the control channel configuration.

The control channels are transmitted using a common resource. The Rel-8 LTE terminal and the LTE-A terminal perform blind determination and detect control information addressed to them. A downlink physical channel transmitted from the base station multiplexes a physical downlink control channel (PDCCH) and a physical downlink shared channel (PDSCH) (e.g., 3GPP TS 36.211 V8 3.0 [2008-05] 6.8, Physical downlink control channel, 3GPP TS 36.212 V8.3.0 [2008-05] 5.3.3, Downlink control information, and 3GPP TS 36.213 V8.3.0 [2008-05] 7, Physical downlink shared channel related procedures).

A terminal receives the PDCCHs and detects the assignment information of information transmission channels PDSCH of the terminal based on the PDCCHs for the terminal. The terminal then receives the PDSCHs based on the PDSCH assignment information. The PDCCHs are scrambled in different ways for the respective terminals. Each terminal decodes the PDCCHs using a unique decoding method and determines a correctly detected PDCCH as the PDCCH for the terminal. This processing is called blind determination.

As the control channel transmission method, control information for a Rel-8 LTE terminal and that for a broadband terminal may be transmitted using different resources. However, this resource use method cannot be efficient because the terminal existence ratio dynamically changes, as described above.

For this reason, there is a demand for development of a system which allows a Rel-8 LTE terminal (broadband reception apparatus) to receive PDCCHs without changing its specifications and an LTE-A terminal (narrowband reception apparatus) to efficiently receive PDCCHs.

### BRIEF SUMMARY OF THE INVENTION

The present invention has been made to meet the above requirement, and has as its object to provide a wireless transmission apparatus, a wireless reception apparatus, and a transmission method, which allow a narrowband reception apparatus to receive information without changing its specifications and a broadband reception apparatus to efficiently receive information when transmitting channel assignment information to the narrowband reception apparatus and the broadband reception apparatus using a common resource.

To achieve the object, an aspect of the present invention is a wireless transmission apparatus which notifies a wireless reception apparatus of channel assignment via channel assignment information using a first scheme of performing wireless transmission using channels within a range of a first bandwidth and a second scheme of performing wireless transmission using channels within a range of a second bandwidth including the first bandwidth, and transmits data. The wireless transmission apparatus comprises a first channel assignment unit which transmits, to a wireless reception apparatus of the second scheme, first channel assignment information representing channels to be assigned; a second channel assignment unit which transmits, to the wireless reception apparatus of the second scheme via the channels represented by the first channel assignment information, second channel assignment information representing other channels to be assigned; and a data transmission unit which transmits data to the wireless reception apparatus of the second scheme via the channels corresponding to the second channel assignment information.

As described above, in the present invention, the first channel assignment information representing the channels to be assigned to the wireless reception apparatus of the second scheme is transmitted. The second channel assignment information representing other channels to be assigned is transmitted via the channels represented by the first channel assignment information. Then, data is transmitted to the wireless reception apparatus of the second scheme via the channels corresponding to the second channel assignment information.

According to the present invention, the other channels to be assigned can be sent via the first channel assignment information. It is therefore possible to provide a wireless transmission apparatus, a wireless reception apparatus, and a transmission method, which allow a narrowband reception apparatus of the first scheme to receive information without changing its specifications and a broadband reception apparatus of the second scheme to efficiently receive information when transmitting channel assignment information to the narrowband reception apparatus and the broadband reception apparatus using a common resource.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view for explaining communication bands used in a wireless communication system according to the present invention;

FIG. 2 is a view for explaining a resource block assigned to subcarriers shown in FIG. 1;

FIG. 3 is a view for explaining channels assigned to the resource block shown in FIG. 2;

FIG. 4 is a view for explaining POOCH assignment to a mobile wireless terminal conforming to LTE-Advanced;

FIG. 5 is a block diagram showing the arrangement of a wireless base station in a wireless communication system according to an embodiment of the present invention; and

FIG. 6 is a block diagram showing the arrangement of a mobile wireless terminal, in the wireless communication system according to the embodiment of the present invention.

### DETAILED DESCRIPTION OF THE INVENTION

An embodiment of the present invention will now be described with reference to the accompanying drawing.

A wireless communication system according to the present invention will be described by exemplifying a cellular system using OFDM in the downlink. This wireless communication system includes mobile wire terminals and a wireless base station and performs wireless communication using OFDM in the downlink transmitted from the wireless base station and received by the mobile wireless terminals. There are two types of mobile wireless terminals, i.e., a type x conforming to Rel-8 LTE and a type y conforming to LTE-Advanced (LTE-A). The wireless base station transmits signals to a plurality of mobile wireless terminals of type x and a plurality of mobile wireless terminals of type y.

The maximum receivable bandwidth of the mobile wireless terminal of type x is one component (18.015 MHz). The maximum receivable bandwidth of the mobile wireless terminal of type y includes one component (18.015 MHz) and the bands between this component and other components adjacent to it. The wireless base station transmits signals receivable by the mobile wireless terminals of both types.

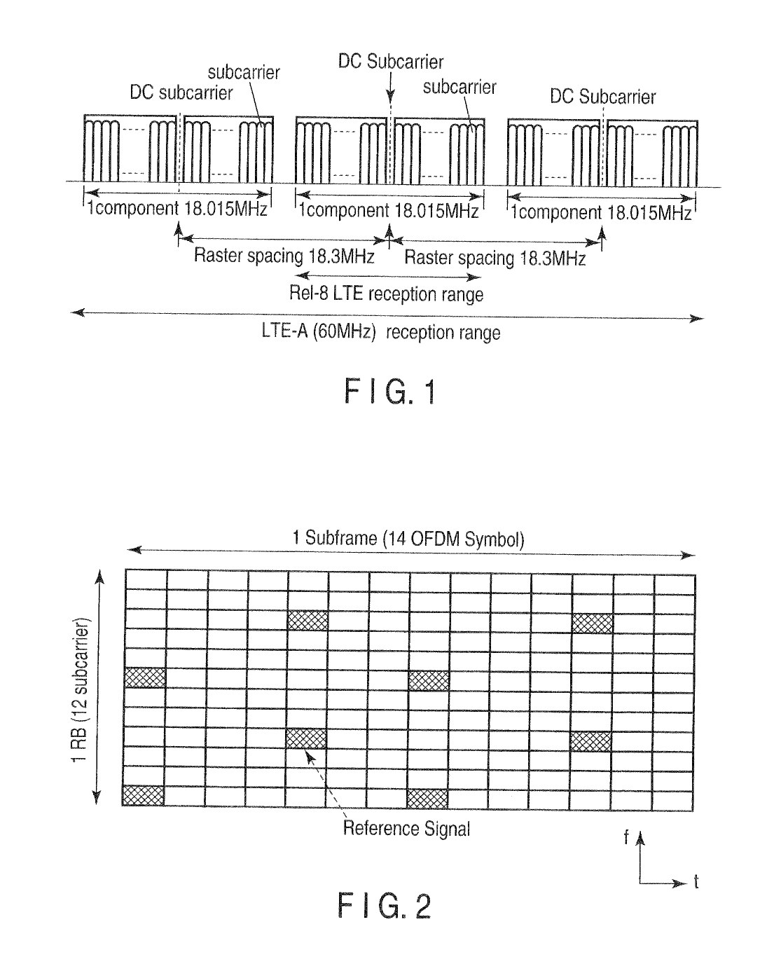

As shown in FIG. 1, the wireless base station arranges a DC subcarrier at the center frequency of one component, thereby forming a transmission signal band of 19.015 MH (number of subcarriers=1201). That is, the subcarrier spacing is 15 kHz. Mote that the wireless base station transmits no signal on the DC subcarrier. In addition, the wireless base station forms one resource block (RB) by a 180 kHz bandwidth containing 12 subcarriers, as shown in FIG. 2. Hence, one component includes 100 RBs.

Note that an RB includes 14 symbols in the time direction. Reference signals which are known signals as the reference of a received signal are inserted.

One channel bandwidth of the wireless base station is 20 MHz. The difference between it and one component of 18.015 MHz, i.e., 1.985 MHz (0.9925 MHz on each side) serves as a guard band. The guard band is not used to transmit signals considering the design of element components such as the transmission filter of the wireless base station and the reception filter of the mobile wireless terminal that are hard to obtain ideal characteristics. The system description may regard the transmission signal bandwidth as 18 MHz and the guard bandwidth as 2 MHz (1 MHz on each side) excluding the DC suhcarrier.

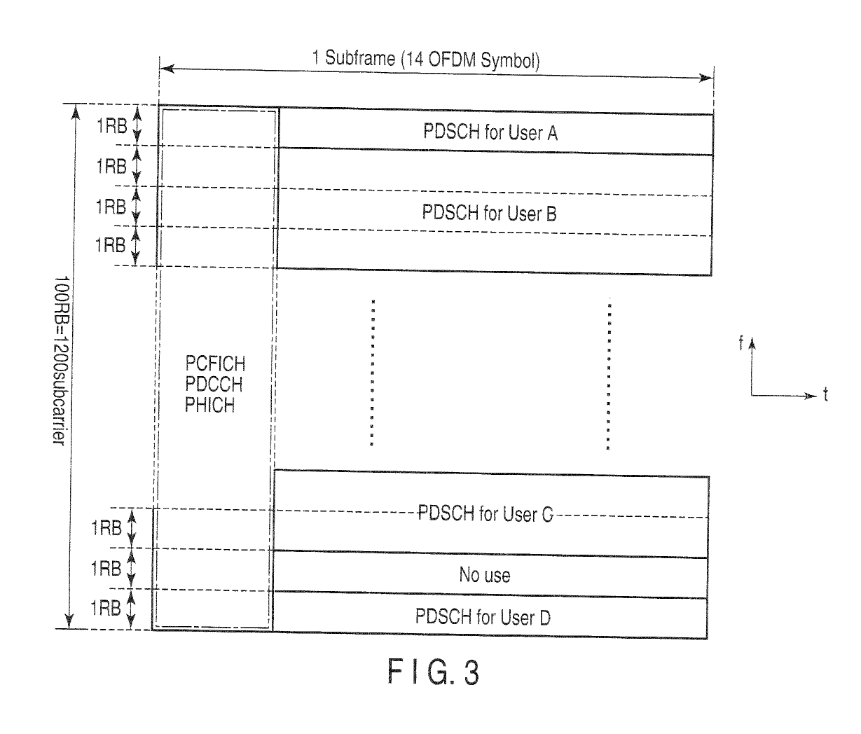

FIG. 3 shows the structure of a transmission signal of one subframe the wireless base station transmits to the mobile wireless terminals of types x and y. In FIG. 3, the RHs are arranged in the frequency direction. The signal transmitted from the wireless base station to the mobile wireless terminals of types x and y includes control channels (PCFICH, PDCCH, and PHICH) to transmit control information and data channels (PDSCH) to transmit transmission information. These channels are time-divisionally distributed and transmitted. FIG. 3 does not illustrate the DC subcarrier which transmits no signal and is therefore insignificant from the viewpoint of transmis r r of control channels and data channels.

PDSCHs transmit information to the mobile wireless terminals of types x and y in the respective RIM. Hence, each of the mobile wireless terminals of types x and y receives the PDCCHs for it. Based on the information, each mobile wireless terminal specifies the BBs to which the PDSCHs for the terminal are assigned and receives only the specified RBs (PDSCHs) for the terminal. More specifically, the wireless base station makes PDCCHs include assignment information representing which PDSCH is assigned to which mobile wireless terminal.

The wireless base station multiplexes and arranges the PDCCHs for the mobile wireless terminals of types x and y throughout the signal band. The arrangement positions are not fixed for the respective mobile wireless terminals. For this reason, each mobile wireless terminal needs to search for (blind-detect) PDCCHs addressed to it from the multiplexed PDCCHs.

Each of the mobile wireless terminals of types x and y receives the PDCCHs for it. Based on the information, each mobile wireless terminal specifies the RBs to which the PDSCHs for the terminal are assigned and receives only the specified RBs (PDSCHs) for the terminal. More specifically, the wireless base station makes PDCCHs include assignment information representing which PDSCH is assigned to which mobile wireless terminal.

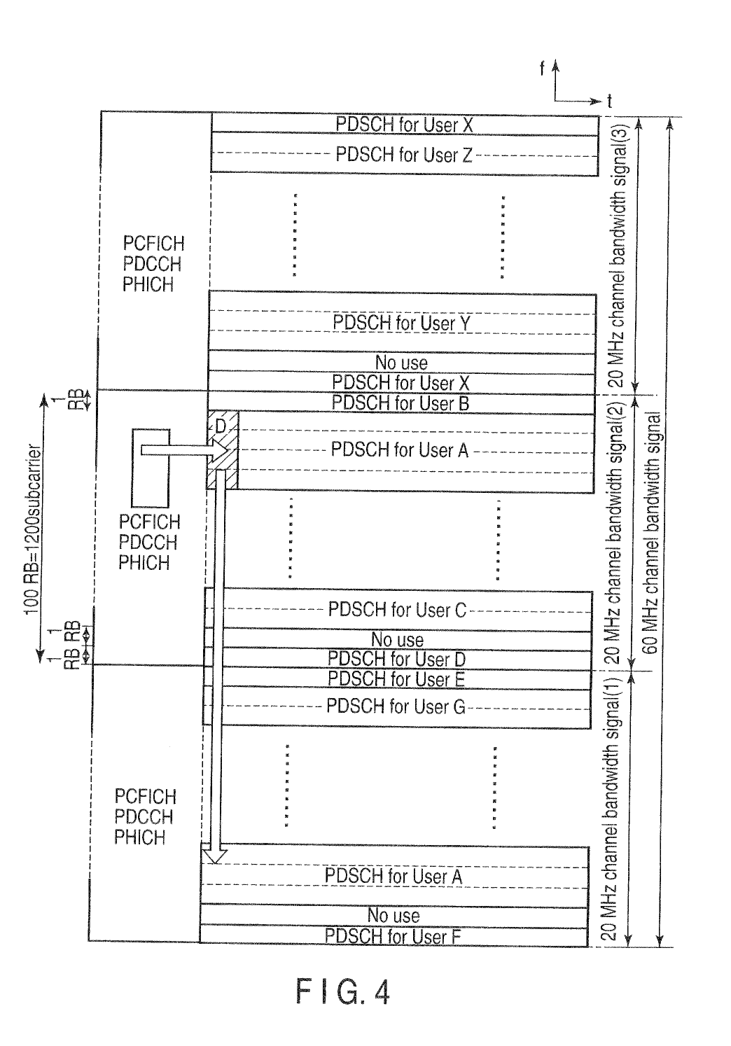

As described above, the mobile wireless terminal of type x can receive one component. The wireless base station assigns one or more RBs in the component for PDSCH reception. That is, referring to FIG. 4, the mobile wireless terminal of type x corresponds to one of Users B to B and X to Z. On the other hand, the mobile wireless terminal of type y can receive three components at the same time. The wireless base station assigns one or more Ras in the components for PDSCH reception. Note that it is possible to assign, to the mobile wireless terminal of type y, a plurality of RBs belonging to different components for PDSCH reception. That is, referring to FIG. 4, the mobile wireless terminal of type y corresponds to User A.

The mobile wireless terminal of type x can use only one component. Hence, the wireless base station arranges PDCCHs and PDSCHs for each mobile wireless terminal of type x in a single component so that the mobile wireless terminal of type x need only perform blind detection in one component.

On the other hand, the mobile wireless terminal of type y can use three components. The wireless base station arranges PDCCHs for each mobile wireless terminal of type y in a single component, like the mobile wireless terminal of type x, and PDSCHs in a plurality of components.

As shown in FIG. 4, the wireless base station provides, in a PDSCH (to be referred to as a representative channel hereinafter) designated by a PDCCH for the mobile wireless terminal of type y, a region D including the identification information of the PDSCHs assigned to the mobile wireless terminal of type y. That is, the wireless base station assigns the PDSCHs on the plurality of components to the mobile wireless terminal of type y via the representative channel.

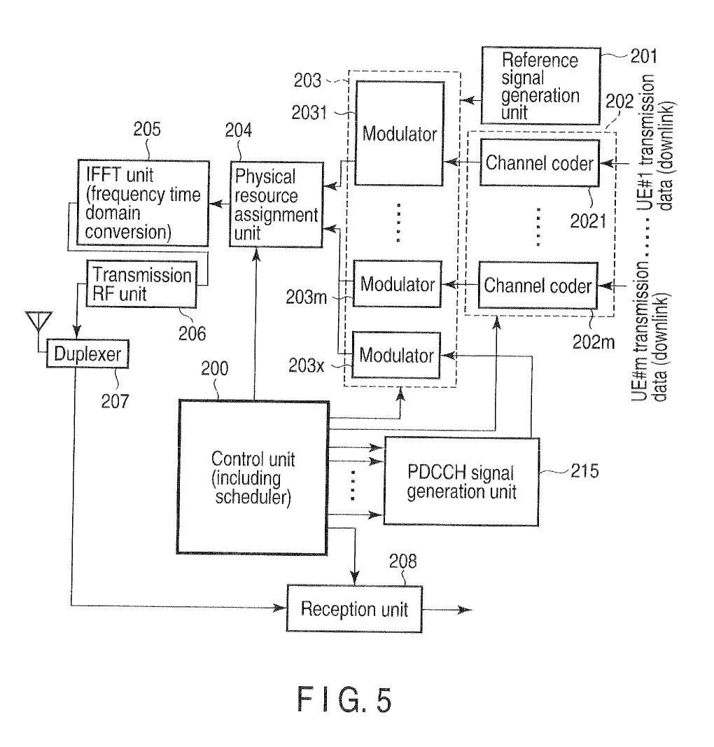

The arrangement of the wireless base station will be explained. FIG. 5 shows the arrangement.

A reference signal generation unit 201 generates a bitstream that is the base of a reference signal. The bitstream is scrambled and then output to a modulation unit 203. A channel coding unit 202 includes channel coders 202l to 202m.

The channel coders 202l to 202m channel-code transmission information (downlink transmission data bitstreams) to be transmitted via data channels or assignment information supplied from a control unit 200 at a channel coding rate designated by the control unit 200. The channel coders 202l to 202m output the downlink transmission, data signals thus obtained to the modulation unit 203. Note that the downlink transmission data bitstreams include data addressed to the mobile wireless terminals of type x and data addressed to the mobile wireless terminals of type y.

A PDCCH signal generation unit 215 receives PDCCH data generated by the control unit 200 and addressed to) a mobile wireless terminal of type x or a mobile wireless terminal of type y. That is, the PDCCH signal generation unit 215 receives PDCCH data addressed to a terminal of the LTE-A system or a terminal of the Rel-8 LTE system. The PDCCH data include identification information of PDSCHs assigned to a terminal. The PDCCH signal generation unit 215 executes processing such as channel coding, multiplexing, and interleaving for the PDCCH data, thereby obtaining PDCCH signals.

The modulation unit 203 includes modulators 2031 to 203m corresponding to the channel coders 202l to 202m, respectively, and a modulator 203x corresponding to the PDCCH signal generation unit 215. In accordance with a modulation method designated by the control unit 200, the modulators 2031 to 203m and 203x perform digital modulation such as quadrature phase-shift keying (QPSK) for the reference signals, the downlink transmission data signals, and the PDCCH signals.

A physical resource assignment unit 204 receives the signals digitally modulated by the modulators 2031 to 203m and 203x and PCFICH signals and PHICH signals generated by the control unit 200. The physical resource assignment unit 204 assigns these signals to the subcarriers (resource blocks) of predetermined channels (control channels and data channels) designated by the control unit 200. Note that “assigning a signal to a subcarrier” indicates “adding, to a signal expressed by a complex value, a subcarrier index representing the position on the time and frequency axes of a subcarrier in a corresponding resource block.

Note that the channel band transmitted from the wireless base station is divided into the above-described RBs. Subcarriers arranged in each channel band are put together into one RB. This can uniquely be obtained based on channel band information and the number of resource blocks sent from the wireless base station to each mobile wireless terminal in advance. The mobile wireless terminal also recognizes the RB structure. In the wireless base station, this is implemented by the control unit 200 and the physical resource assignment unit 204.

An inverse fast. Fourier transformation (IFFT) unit 205 converts a frequency-domain signal output from the physical resource assignment unit 204 into a time-domain signal. A transmission RF unit 206 including a digital-to-analog converter, an upconverter, and a power amplifier converts the signal into a radio-frequency (RE) signal. This radio signal is emitted into space, via a duplexer 207 and an antenna, for reception by the mobile wireless terminals.

A reception unit 208 receives, via the antenna and the duplexer 207, a radio signal transmitted from each mobile wireless terminal.

The control unit 200 comprehensively controls the units of the wireless base station. The control unit 200 includes a scheduler which decides, for each frame, which channel band should be assigned to which mobile wireless terminal and the packet to be used for transmission, based on, e.g., the type (x or y) of the standard (Rel-8 LTE or LTE-A) supported by each mobile wireless terminal, the amount of data for each mobile wireless terminal, and the priority and capabilities (UE capabilities) of each mobile wireless terminal.

Note that the capabilities (UE capabilities) of a mobile wireless terminal and the type of the standard supported by it are detected by the control unit 200 from data received from the mobile wireless terminal. Additionally, in accordance with information representing the channel band assigned to each mobile wireless terminal, the control unit 200 generates PCFICH, PDCCH, and PHICH including the information for the mobile wireless terminal and outputs the pieces of information to the PDCCH signal generation unit 215 and the physical resource assignment unit 204.

Assignment processing to the mobile wireless terminal of type x, i.e., the Rel-8 LTE terminal will be explained first. The scheduler decides channels (PDCCH and PDSCH) to be assigned to the mobile wireless terminal of type x and outputs the identification information of these channels to the physical resource assignment unit 204. The channels PDCCH and POOCH to be assigned to the mobile wireless terminal of type x are limited within the range of the receivable band (one component) of Rel-8 LTE as shown in FIG. 3.

The physical resource assignment unit 204 complies with the decision of the scheduler. More specifically, the physical resource assignment unit 204 assigns the PDCCHs and PDSCHs of the identification information sent from the scheduler to the mobile wireless terminal of type x. The PDCCHs assigned here are used to transmit PDCCH signals based on PDCCH data generated by the PDCCH signal generation unit 215 and include the identification information of the PDSCHs to be assigned to the mobile wireless terminal of type x.

The control unit 200 controls the units of the transmission system to transmit the data to the mobile wireless terminal of type x via the PDSCHs. This processing is executed for each frame. The mobile wireless terminal of type x can recognize the PDSCHs assigned to it by receiving the PDCCHs.

Assignment processing to the mobile wireless terminal of type y, i.e., the LTE-A terminal will be explained next. As shown in FIG. 4, the scheduler decides PDCCHs and a plurality of PDSCHs to be assigned to the mobile wireless terminal of type y and notifies the physical resource assignment unit 204 of the identification information of these channels. The scheduler also decides one of the plurality of assigned PDSCHs as a representative channel. Note that the plurality of PDSCHs for the mobile wireless terminal of type y can be assigned over a plurality of components, as shown in FIG. 4.

The control unit 200 generates PDCCH data including the identification information of the representative channel (PDSCH) and outputs it to the PDCCH signal generation unit 215. The control unit 200 also generates assignment information representing the identification information of the remaining assigned channels (PDSCH) other than the representative channel and outputs it to the channel coding unit 202.

The channel coding unit 202 executes the above-described processing for the assignment information, thereby generating a downlink transmission data signal for the mobile wireless terminal of type y. The modulation unit 203 digitally modulates the signal and outputs it to the physical resource assignment unit 204 as one of the PDSCH signals for the mobile wireless terminal of type y.

The physical resource assignment unit 204 complies with the decision of the scheduler. More specifically, the physical resource assignment unit 204 assigns the PDCCHs and PDSCHs of the identification information sent from the scheduler to the mobile wireless terminal of type y. The PDCCHs assigned here are used to transmit PDCCH signals based on PDCCH data generated by the PDCCH signal generation unit 215 and thus include the identification information of the representative channel (PDSCH).

The physical resource assignment unit 204 assigns PDSCH signals based on the assignment information to region D of the representative channel indicated by the PDCCH. That is, region D of the representative channel is used to transmit the assignment information. Hence, the pieces of identification information of the remaining assigned channels (PDSCH) other than the representative channel are transmitted to the mobile wireless terminal of type y via region D of the representative channel.

The control unit 200 controls the units of the transmission system to transmit the data to the mobile wireless terminal of type y via the plurality of PDSCHs assigned to it. This processing is executed for each frame. The mobile wireless terminal of type y can recognize the PDSCHs assigned to it by receiving the PDCCHs and the PDSCHs (region D) indicated by them.

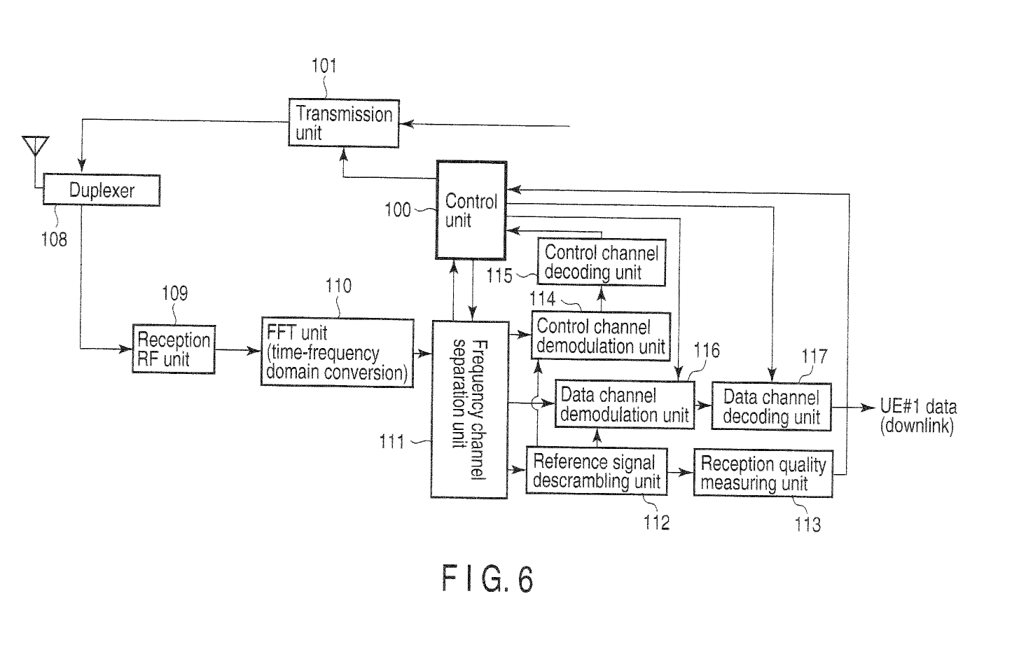

The arrangement of each mobile wireless terminal will be described. FIG. 6 shows the arrangement. As described above, the mobile wireless terminal of type x and the mobile wireless terminal of type y apparently have the same arrangement except for the number of components to be used for reception, the assignment information transmission method, and the arrangement associated with reception. Hence, both apparatuses will be explained using FIG. 6.

A transmission unit 101 generates a radio signal for the wireless base station and emits the signal into the space via a duplexer 108 and an antenna.

The antenna receives a radio signal transmitted from the wireless base station and outputs it to a reception RF unit 109 via the duplex 108. The reception RF unit 109 including a downconverter and an analog-to-digital converter converts the received radio signal into a baseband digital signal.

A fast Fourier transformation (FFT) unit 110 performs fast Fourier transformation of the baseband digital signal, thereby converting the time-domain signal into a frequency-domain signal, i.e., dividing the signal into subcarrier signals. The divided subcarrier signals are output to a frequency channel separation unit 111. Note that the wireless base station puts a predetermined number (e.g., 12) of subcarriers together into a resource block. The wireless base station assigns the subcarriers to a mobile wireless terminal for each resource block.

As for a channel band and resource blocks designated by a control unit 100, the frequency channel separation unit 111 separates the subcarrier signals included in the resource blocks into reference signals, control channel signals, and data channel signals.

Regarding how to divide a channel band into resource blocks, i.e., the correspondence between subcarriers and resource blocks, the wireless base station sends channel band information and the number of resource blocks to each mobile wireless terminal in advance. The correspondence between subcarriers and resource blocks is then obtained uniquely based on the channel band information and the number of resource blocks. That is, each mobile wireless terminal detects in advance how the wireless base station divides a channel band into resource blocks, and receives signals accordingly.

A reference signal descrambling unit 112 descrambles, out of the signals, the reference signal using a descrambling pattern opposite to the scrambling pattern used by the wireless base station which transmits the signal to be received by the mobile wireless terminal. The descrambling result is output to the control channel demodulation unit 114, a data channel demodulation unit 116, and a reception quality measuring unit 113. The reception quality measuring unit 113 measures the reception quality of Ncqi resource blocks based on the reference signal. The measurement result is output to the control unit 100.

The control channel demodulation unit 114 performs channel equalization of the control channel signals output from the frequency channel separation unit 111 using the reference signal descrambled by the reference signal descrambling unit 112 and then demodulates them. The demodulation result is output to a control channel decoding unit 115 together with mapping information representing the components on which the control channels have been mapped.

The control, channel decoding unit 115 detects the PCFICH and the PHICH for the terminal from the demodulated control channel signals. The control channel decoding unit 115 also executes processing such as deinterleaving, separation processing, error correction decoding, and channel decoding for the demodulated control channel signals, thereby blind-detecting the PDCCHs for the terminal. The bitstreams of the control channels (PCFICH, PHICH, and PDCCH) obtained in this way are output to the control unit 100.

The control unit 100 comprehensively controls the units of the mobile wireless terminal. The control dunit 100 controls the units (e.g., frequency channel separation unit 111) of the reception system to detect, based on the PDCCH information acquired from the control channels, the data channels (channel band and resource blocks) assigned to the mobile wireless terminal and receive data from the wireless base station via the data channels. Upon determining that the received signal is addressed to the mobile wireless terminal, the control unit 100 extracts signaling information contained in the signal and detects, from it, information necessary for demodulating data channel signals and information necessary for decoding them.

The information necessary for demodulating the data channel signals is output to the data channel demodulation unit 116. The information necessary for decoding the data channel signals is output to a data channel decoding unit 117. Upon determining that the received signal is not addressed to the mobile wireless terminal, the control unit 100 stops the processing of demodulating and decoding the data channel signals.

In the mobile wireless terminal of type y, the control unit 100 refers to region D of the representative channel (PDSCH) designated by the PDCCH, as shown in FIG. 4, and detects PDSCHs assigned to the terminal based on the assignment information included in region D. The control unit 100 controls the data channel demodulation unit 116 and the data channel decoding unit 117 to receive the detected PDSCHs.

The data channel demodulation unit 116 performs channel equalization of the signals output from the frequency channel separation unit 111 using the reference signal output from the reference signal descrambling unit 112. The data channel demodulation unit 116 then demodulates the PDSCHs designated by the control unit 100 based on a demodulation method designated by the control unit 100 and information output from it.

The data channel decoding unit 117 decodes the demodulated data bitstreams to obtain a downlink data bitstream for the mobile wireless terminal. Decoding here uses the information output from the control unit 100. Before data reception from the wireless base station, the type (x or y) and capabilities (DE capabilities) of the mobile wireless terminal are transmitted to the wireless base station via the uplink.

In the mobile wireless terminal of type y, the assignment information obtained from the representative channel is output to the control unit 100. The control unit 100 controls the data channel demodulation unit 116 and the data channel decoding unit 117 to detect the PDSCHs assigned to the terminal from the assignment information included in region D and receive the channels, as described above. That is, the mobile wireless terminal of type y controls the units of the reception system to receive data via the channels (PDSCHs) corresponding to the assignment information received via the representative channel and region D.

As described above, in the wireless communication system having the above arrangement, the wireless base station notifies the mobile wireless terminal of type y of LTE-A of the assignment information of the representative channel (PDSCH) via a PDCCH, as in the mobile wireless terminal of type x of Rel-8 LTB, and notifies the terminal of the remaining assigned channels (PDSCHs) via the notified representative channel.

Hence, according to the wireless communication system with the above arrangement, it is possible to assign a plurality of channels over a plurality of components to the mobile wireless terminals of type y without changing the assignment sequence for the mobile wireless terminals of type x. More specifically, when transmitting channel assignment information to a narrowband reception apparatus (mobile wireless terminal of type x) and a broadband reception apparatus (mobile wireless terminal of type y) using a common resource, the narrowband reception apparatus can receive the information without changing its specifications, whereas the broadband reception apparatus can efficiently receive the information.

Note that the present invention is not exactly limited to the above embodiments, and constituent elements can be modified in the stage of practice without departing from the spirit and scope of the invention. Various inventions can be formed by properly combining a plurality of constituent elements disclosed in the above embodiments. For example, several constituent elements may be omitted from all the constituent elements described in the embodiments. In addition, constituent elements throughout different embodiments may be properly combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A wireless transmission apparatus which notifies a wireless reception apparatus of channel assignment via channel assignment information using a first scheme of performing wireless transmission using channels within a range of a first bandwidth and a second scheme of performing wireless transmission using channels within a range of a second bandwidth including the first bandwidth, and transmits data, comprising:
a first channel assignment unit which transmits, to a wireless reception apparatus of the second scheme, first channel assignment information representing channels to be assigned;
a second channel assignment unit which transmits, to the wireless reception apparatus of the second scheme via the channels represented by the first channel assignment information, second channel assignment information representing other channels to be assigned; and
a data transmission unit which transmits data to the wireless reception apparatus of the second scheme via the channels corresponding to the second channel assignment information.

2. The apparatus according to claim 1, wherein
the first channel assignment unit transmits the first channel assignment information via channels to transmit control information, and
the second channel assignment unit transmits the second channel assignment information via channels to individually transmit data.

3. The apparatus according to claim 1, wherein the data transmission unit transmits the data to the wireless reception apparatus of the second scheme via the channels corresponding to the first channel assignment information and the channels corresponding to the second channel assignment information.

4. A wireless transmission apparatus which notifies a wireless reception apparatus of channel assignment via channel assignment information using a first scheme of performing wireless transmission using channels within a range of a first bandwidth and a second scheme of performing wireless transmission using channels within a range of a second bandwidth including the first bandwidth, and transmits data, comprising:
a first channel assignment unit which transmits, to a wireless reception apparatus of the second scheme, first channel, assignment information representing some of a plurality of channels to be assigned;
a second channel assignment unit which transmits, to the wireless reception apparatus of the second scheme via the channels represented by the first channel assignment information, second channel assignment information representing remaining channels of the plurality of channels to be assigned; and
a data transmission unit which transmits data to the wireless reception apparatus of the second scheme via the channels corresponding to the second channel assignment information.

5. The apparatus according to claim 4, wherein
the first channel assignment unit transmits the first channel assignment information via channels to transmit control information, and
the second channel assignment unit transmits the second channel assignment information via channels to individually transmit data.

6. The apparatus according to claim 4, wherein the data transmission unit transmits the data to the wireless reception apparatus of the second scheme via the channels corresponding to the first channel assignment information and the channels corresponding to the second channel assignment information.

7. A wireless reception apparatus which communicates with a wireless transmission apparatus using a second scheme, the wireless transmission apparatus notifying the wireless reception apparatus of channel assignment via channel assignment information using a first scheme of performing wireless transmission using channels within a range of a first bandwidth and the second scheme of performing wireless transmission using channels within a range of a second bandwidth including the first bandwidth, comprising:
a first assignment information reception unit which receives first channel assignment information;
a second assignment information reception unit which receives, via channels represented by the first channel assignment information, second channel assignment information representing other channels to be assigned; and
a data reception unit which receives data transmitted from the wireless transmission apparatus via the channels corresponding to the second channel assignment information.

8. The apparatus according to claim 7, wherein
the first assignment information reception unit receives the first channel assignment information via channels to transmit control information, and
the second assignment information reception unit receives the second channel assignment information via channels to individually transmit data.

9. The apparatus according to claim 7, wherein the data reception unit receives the data transmitted from the wireless transmission apparatus, via the channels corresponding to the first channel assignment information and the channels corresponding to the second channel assignment information.

10. A wireless reception apparatus which communicates with a wireless transmission apparatus using a second scheme, the wireless transmission apparatus notifying the wireless reception apparatus of channel assignment via channel assignment information using a first scheme of performing wireless transmission using channels within a range of a first bandwidth and the second scheme of performing wireless transmission using channels within a range of a second bandwidth including the first bandwidth, comprising:
a first assignment information reception unit which receives first channel assignment information to assign some of a plurality of channels to be assigned by the wireless transmission apparatus;
a second assignment information reception unit which receives, via the channels represented by the first channel assignment information received by the first assignment information reception unit, second channel assignment information to assign remaining channels of the plurality of channels to be assigned by the wireless transmission apparatus; and
a data reception unit which receives data transmitted from the wireless transmission apparatus, via the channels corresponding to the second channel assignment information.

11. The apparatus according to claim 10, wherein
the first, assignment information reception unit receives the first channel assignment information via channels to transmit control information, and
the second assignment information reception unit receives the second channel assignment information via channels to individually transmit data.

12. The apparatus according to claim 10, wherein the data reception unit receives the data transmitted from the wireless transmission apparatus via the channels corresponding to the first channel assignment information and the channels corresponding to the second channel assignment information.

13. A transmission method of notifying a wireless reception apparatus of channel assignment, via channel assignment information using a first scheme of performing wireless transmission using channels within a range of a first bandwidth and a second scheme of performing wireless transmission using channels within a range of a second bandwidth including the first bandwidth, and transmitting data, comprising steps of:
transmitting, to a wireless reception apparatus of the second scheme, first channel assignment information representing channels to be assigned;
transmitting, to the wireless reception apparatus of the second scheme via the channels represented by the first channel assignment information, second channel assignment information representing other channels to be assigned; and
transmitting data to the wireless reception apparatus of the second scheme via the channels corresponding to the second channel assignment information.

14. A transmission method of notifying a wireless reception apparatus of channel assignment via channel assignment information using a first scheme of Performing wireless transmission using channels within a range of a first bandwidth and a second scheme of performing wireless transmission using channels within a range of a second bandwidth including the first bandwidth, and transmitting data, comprising steps of:
transmitting, to a wireless reception apparatus of the second scheme, first channel assignment information representing some of a plurality of channels to be assigned;
transmitting, to the wireless reception apparatus of the second scheme via the channels represented by the first channel assignment information, second channel assignment information representing remaining channels of the plurality of channels to be assigned; and
transmitting data to the wireless reception apparatus of the second scheme via the channels corresponding to the second channel assignment information.
